(19) United States
(12) Patent Application Publication
(10) Pub. No.: US 2010/0252192 A1
(43) Pub. Date: Oct. 7, 2010

(54) ADHESIVE SHEET FOR SEALING VESSELS AND CHANNELS, PRODUCTION AND USE THEREOF

(75) Inventors: Ingo NEUBERT, Norderstedt (DE); Maren KAMPERS, Seevetal (DE); Thorsten KRAWINKEL, Hamburg (DE); Nico DIAMANTIS, Bonningstedt (DE)

Correspondence Address: GERSTENZANG, WILLIAM C.;NORRIS MCLAUGHLIN & MARCUS, PA, 875 THIRD AVE, 8TH FLOOR, NEW YORK, NY, 10022, US

(73) Assignee: TESA SE, Hamburg (DE)

(21) Appl. No.: 12/504,228

(22) Filed: Jul. 16, 2009

(30) Foreign Application Priority Data
Apr. 3, 2009 (DE) 10 2009 016 109.0
Jun. 29, 2009 (DE) 10 2009 027 283.6

(51) Int. Cl. B32B 37/12; B32B 3/00

(52) U.S. Cl. 156/292; 428/141

(57) ABSTRACT

Adhesive sheet particularly for sealing vessels and channels in which chemical, biological or biochemical reactions are conducted, composed of a backing film coated on one side with a pressure-sensitive adhesive, characterized in that the adhesive sheet has a transmittance of at least 89% (in the wavelength range between 450 to 750 nm) and a HAZE value of not more than 3% and the surface of the pressure-sensitive adhesive has a surface roughness Rₐ of not more than 0.03 μm and R_{z} of not more than 0.10 μm, the refractive index of the pressure-sensitive adhesive being less than 1.55, and the difference in the refractive indices of pressure-sensitive adhesive and of backing film being not more than 0.1.

The present invention relates to an adhesive sheet composed of a backing film provided on one side with an adhesive, and useful in particular for sealing vessels and channels in which biological or biochemical reactions are carried out, and also to the production and the use thereof.

To carry out modern analytical techniques in biology, biochemistry and medicine it is common to use vessels such as, for example, microtitre plates or biosensors, or what are called microfluidic devices with microchannels. Microtitre plates are typically composed of a plastic plate comprising a plurality of mutually isolated depressions in rows and columns that serve as reaction vessels for the biochemical processes. There are microtitre plates with 6, 12, 24, 48, 96, 384 or 1536 such depressions, known as wells. Microfluidic devices are micrometre-scale reactors in which, for example, chemical or biochemical reactions or physical processes are carried out. Biochemical processes are exemplified by DNA amplification techniques such as ligase (LCR) or polymerase (PCR) chain reaction and strand displacement amplification (SDA), and also determination of blood sugar concentration by means of glucose oxidase tests strips.

For the biochemical and analytical processes and techniques, the vessels and channels are typically covered or sealed in order to prevent disruptive environmental influences, loss of fluid or else cross-contamination. For this purpose it is common to use single-sidedly adhesive sheets.

These adhesive sheets must possess sufficient bond strength to adhere well, and in addition the sheets and the bond site must as far as possible be of low water vapour permeability, in order to prevent loss of liquid, or drying out, during storage or during the biochemical reaction, which may also take place at relatively high temperatures of 98° C.

Moreover, the adhesive sheets ought to be removable without residue after application. The adhesives on the adhesive sheets ought to possess a certain heat stability, since otherwise, for example during the PCR application, with temperatures of almost 105° C., it is easy for creases to form in the sheet, which may mean that some of the wells, especially those in the corners, are open and, as a result of drying out, become unusable. Moreover, the adhesive sheets are desirably of low initial tack, in order to facilitate use more particularly with latex gloves, as are commonly worn in bioanalytical laboratories.

The PCR method (PCR=polymerase chain reaction) of DNA amplification has gained very greatly in significance in biochemistry over the last 20 years and is presently employed as a modern, standard method in analytical and research laboratories. Applications are, for example, the detection of diseases, the determination of genetic fingerprint, the cloning of genes, and the development of drugs (active compound detection, detection of secondary reactions).

One specific PCR technique is the application of real time quantitative PCR. The real time quantitative PCR method uses fluorescent dyes, for example Cyber Green. With DNA molecules which form in the course of PCR amplification, the dyes form a complex with fluorescence activity. As a consequence of this it is possible to monitor directly the progress, i.e. the number of DNA strands formed, via the fluorescence signal. The effective monitoring of PCR amplification requires a maximum fluorescence yield and/or a minimum signal/noise ratio. Real time quantitative PCR is typically carried out using microtitre plates covered with an adhesive sheet. In this case the fluorescence signal is monitored through the adhesive sheet. This is done by irradiating light through the adhesive sheet into the sample, and then reading out the fluorescence signal again through the adhesive sheet. With this method, therefore, radiation is passed twice through the adhesive sheet, and so the adhesive sheet is accorded particular significance. A maximum fluorescence yield and a minimum signal/noise ratio requires the adhesive sheet to have a very high transparency.

In the literature there are a variety of adhesives described for adhesive sheets which are employed in the stated applications; adhesives based on silicones have shown themselves to be particularly advantageous.

U.S. Pat. No. 6,703,120 B describes silicone-based adhesives of this kind for this application. An advantage of these adhesives is that they ensure good processing properties, owing to the very low initial tack. Moreover, their bond strength is high, and so the loss of liquid by evaporation after passage through PCR cycles (typically 30 cycles) is only about 1%. The specimens based on pressure-sensitive silicone adhesive have a transmittance of 81% to 85% (depending on wavelength) and a HAZE value of 8%.

Disadvantageous features are, in particular, the high price that must be paid for silicone adhesives, and the difficulty of finding a suitable protective liner, since only release films or release papers with fluorosilicone ensure an adequate release effect with respect to silicone adhesives.

Adhesives with acrylates typically exhibit excessive permeability to water vapour. When adhesive sheets with acrylate adhesives are used, high losses of liquid are observed in the PCR application. Masking sheets presently on the market are used exclusively for standard applications. The transmittance of these masking sheets is <80%.

The transparency and transmittance of an object are dependent on its extinction coefficient, the reflection at the surfaces, and the wavelength of the light used for the investigation. The extinction coefficient is specific to a particular substance, and dependent on the absorption of the material used. In order to obtain a material having a high transmittance it is necessary to avoid both absorption and reflection.

Reflection occurs at all surfaces and interfaces between materials. It is dependent first on the surface roughness and second on the refractive index of the materials used. At a rough surface there is an addition of a diffuse scattered reflection. The connection between the reflection at an interface and the refractive index of the bordering layers is described by the Fresnel equation. In the special case of transparent materials with a vertically incident light beam, and with the effect of the wavelength disregarded, the Fresnel equation can be simplified as follows:

R=(n₂−n₁)²/(n₂+n₁)² eq. 1
R=reflection at the interface
n₁=refractive index, medium 1
n₂=refractive index, medium 2
refractive index air nₐᵢᵣ≈1

Reflection occurs at all interfaces and so reduces the transmission coefficient of an object. Thus, for example, the maximum achievable transmittance of a polyester film having a refractive index n₂=1.6, assuming that the light beam obeys the Fresnel reflection law both when entering the film and when exiting the film, cannot exceed a value of 90%.

It is an object of the present invention to provide an adhesive sheet which is outstandingly suitable for the sealing of channels and reaction vessels, especially microtitre plates, and which does not have the disadvantages of the known adhesives and adhesive sheets, or not to such a great extent.

This object is achieved in accordance with the invention by means of an adhesive sheet as specified in the main claim. The dependent claims provide advantageous embodiments and developments of the adhesive sheet, production processes, and the use of the adhesive sheet of the invention.

The invention accordingly provides an adhesive sheet particularly for sealing vessels and channels in which chemical, biological or biochemical reactions are conducted, composed of a backing film which is coated on one side with a pressure-sensitive adhesive, in other words a viscoelastic composition which at room temperature in the dry state remains permanently tacky and adhesive, the adhesion occurring by gentle applied pressure, immediately on virtually all substrates, where
the adhesive sheet has a transmittance of at least 89% (in the wavelength range between 450 to 750 nm), advantageously of at least 91%, and a HAZE value (measure of the light scattering) of not more than 3%,
the (free) surface of the pressure-sensitive adhesive has a surface roughness Rₐ of not more than 0.03 μm and R_{z}, of not more than 0.10 μm, advantageously a surface roughness Rₐ of not more than 0.02 μm and R_{z} of not more than 0.07 μm,
the refractive index of the pressure-sensitive adhesive is less than 1.55, and
the difference in the refractive indices of pressure-sensitive adhesive and backing film is not more than 0.1, advantageously not more than 0.03.

Adhesives employed are preferably those based on block copolymers comprising polymer blocks formed predominantly from vinylaromatics (A blocks), preferably styrene, and blocks formed predominantly by polymerization of 1,3-dienes (B blocks), preferably butadiene and isoprene. Both homopolymer blocks and copolymer blocks can be utilized in accordance with the invention. Resulting block copolymers may comprise identical or different B blocks. The block copolymers are preferably partly, selectively or fully hydrogenated. Block copolymers may have a linear A-B-A structure. It is likewise possible to employ block copolymers of radial architecture, and also star-shaped and linear multiblock copolymers. Further components present may be A-B diblock copolymers. Block copolymers of vinylaromatics and isobutylene can likewise be employed in accordance with the invention. All of the aforementioned polymers may be utilized alone or in a mixture with one another.

The vinylaromatic block copolymers are preferably styrene block copolymers.

At least some of the block copolymers employed are advantageously acid-modified or acid anhydride-modified, the modification taking place principally by free-radical graft copolymerization of unsaturated monocarboxylic and polycarboxylic acids or acid anhydrides such as, for example, fumaric acid, itaconic acid, citraconic acid, acrylic acid, maleic anhydride, itaconic anhydride or citraconic anhydride, preferably maleic anhydride. The fraction of acid and/or acid anhydride is preferably between 0.5% and 4% by weight, based on the total block copolymer.

Commercially, block copolymers of this kind are available, for example, under the names Kraton FG 1901 and Kraton FG 1924 from Kraton and Tuftec M 1913 and Tuftec M 1943 from Asahi.

The pressure-sensitive adhesive preferably has a fraction of 20% to 70% by weight of vinylaromatic block copolymer, preferably 30% to 60% by weight, and more preferably 35% to 55% by weight, based in each case on the total adhesive, it not being necessary for the total fraction of block copolymers to be anhydride-modified and/or acid-modified.

Besides the aforementioned acid- or acid anhydride-modified vinylaromatic block copolymers it is also possible for elastomers and/or further acids or acid anhydrides to be added as well, in order to achieve a higher degree of crosslinking and hence an even further-improved cohesion. In this context it is possible to employ not only monomeric acid anhydrides and acids, as are described in U.S. Pat. No. 3,970,608 A1, but also acid- or acid anhydride-modified polymers and also acid anhydride-containing copolymers such as polyvinyl methyl ether-maleic anhydride copolymers, obtainable for example under the name Gantrez, sold by the company ISP.

In accordance with another advantageous embodiment of the invention the pressure-sensitive adhesive used is composed advantageously of at least one acid- or acid anhydride-modified vinylaromatic block copolymer, of at least one tackifying resin and, preferably, of at least one metal chelate.

The pressure-sensitive adhesive may further comprise metals or metal chelates as crosslinkers. The metals of the metal chelates may be from main groups 2, 3, 4 and 5 and the transition metals. Particular suitability is possessed for example by aluminium, tin, titanium, zirconium, hafnium, vanadium, niobium, chromium, manganese, iron, cobalt and cerium. Aluminium and titanium are particularly preferred.

Crosslinking of maleic anhydride-modified block copolymers with chelates is known from EP 1 311 559 A2, where an increase in the cohesion of the block copolymer mixtures is described.

In accordance with one advantageous embodiment of the invention the metal chelates may be expressed by the following formula:

(R₁O)nM(XR₂Y)m,
where
M is a metal as described above;
R₁ is an alkyl or aryl group such as methyl, ethyl, butyl, isopropyl or benzyl;
n is zero or a larger whole number;
X and Y are oxygen or nitrogen, and may each also be attached to R₂ through a double bond;
R₂ is an alkylene group which joins X and Y, which may be branched and/or may also contain oxygen or further heteroatoms in the chain;
m is a whole number, but is at least 1.

Preferred chelate ligands are those formed from the reaction of the following compounds: triethanolamine, 2,4-pentanedione, 2-ethyl-1,3-hexanediol or lactic acid.

Particularly preferred crosslinkers are aluminium and titanium acetylacetonates.

Adhesives based on acid-modified vinylaromatic block copolymers crosslinked via metal chelates possess a significantly reduced initial tack as compared with typically employed adhesives based on vinylaromatic block copolymers. The bond strength, nevertheless, is still high enough to achieve an evaporation rate of below 1% in these adhesive systems as well, in the context of their use in an adhesive sheet used for microtitre covering. Moreover, these adhesives can be detached again to outstanding effect without leaving residues of adhesive on the microtitre plates. Nor are any residues of adhesive left hanging on a syringe used to puncture the sheet.

The advantageous adhesives additionally employ tackifiers, especially tackifying resins, which are compatible with the elastomer block of the vinylaromatic block copolymers. Preferential suitability is possessed by, among others, unhydrogenated resins, partially hydrogenated resins or fully hydrogenated resins based on rosin and rosin derivatives, hydrogenated polymers of dicyclopentadiene, unhydrogenated, partially, selectively or fully hydrogenated hydrocarbon resins based on C₅, C₅/C₉ or C₉ monomer streams, polyterpene resins based on α-pinene and/or β-pinene and/or δ-limonene, hydrogenated polymers of preferably pure C₈ and C₉ aromatics. Aforementioned tackifying resins may be used either alone or in a mixture.

For use in PCR, the resins used are more particularly those which are colourless; ideally, hydrogenated hydrocarbon resins based on C₅, C₅/C₉ or C₉.

Through a suitable choice of the colourless tackifying resins added it is possible to produce adhesives and adhesive sheets which do not affect the optical analyses of the samples or the fluorescence measurement, and which do not reduce, by absorption, the transparency of the adhesive sheet of the invention.

The tack of the pressure-sensitive adhesive may optionally be first produced by thermal activation or by solvent activation.

The adhesives exhibit particularly good adhesion to polypropylene and polystyrene, the materials from which the microtitre plates are commonly produced.

The adhesives are likewise resistant to certain chemicals used in analysis, especially to polar solvents such as DMSO (dimethylsulphoxide).

The backing of the adhesive sheet is a polymeric film having a high transparency. The polymeric films may be composed of polypropylene or of polyethylene terephthalate, and have a transmittance of at least 88% and preferably a refractive index of not more than 1.6. The backing film may be monoaxially or biaxially oriented and may be composed of a monolayer or of two or more coextrusion layers.

(The reported value for the transmittance refers to the polymeric film; the value reported above refers to the coated product. The transmittance is improved slightly by the coating.)

The present invention takes account of the physical laws of optics. In order to achieve maximum transparency on the part of the adhesive sheet, the following points are taken into account:
use of a pressure-sensitive adhesive having a refractive index of not more than 1.55, in order to minimize the reflection at the interface between the adhesive with the air
the difference in the refractive indices of the pressure-sensitive adhesive and of the backing film is not more than 0.1 and advantageously not more than 0.03, in order as far as possible to prevent reflection at the pressure-sensitive adhesive/backing film interface.

In order to optimize the transparency, furthermore, raw materials or additives are avoided in the pressure-sensitive adhesive and/or backing film if they cause absorption or inherent fluorescence.

In accordance with one advantageous embodiment, therefore, pressure-sensitive adhesive and/or backing film are free from raw materials and/or additives which cause absorption and/or inherent fluorescence.

In accordance with one advantageous embodiment of the invention, the preparation of a pressure-sensitive adhesive having a surface roughness Rₐ of not more than 0.03 μm and R_{z} of not more than 0.10 μm is achieved by coating a very smooth auxiliary material with the pressure-sensitive adhesive and then laminating it with the backing material. Suitable coating techniques here include the customary coating techniques, examples being engraved roller application, comma bar coating, multi-roll coating, and also printing techniques. Particularly suitable for producing a very smooth pressure-sensitive adhesive surface are contactless coating techniques with preliminary metering, such as nozzle coating operations, for example. With a contactless coating technique with preliminary metering, a particularly uniform and defect-free coating is achieved with high precision and a smooth surface. Particularly preferred, as a specific nozzle coating technique, is curtain coating. In curtain coating, a coating film falls, after its emergence from the nozzle, in the manner of a curtain, onto the web to be coated, which is moving along beneath it. This contactless coating produces a more uniform and—depending on the viscosity and web speed—very much thinner coating film as compared with other conventional coating techniques. With particular preference in accordance with the invention the pressure-sensitive adhesive is coated from a solvent. Advantageously the coating solution is filtered immediately prior to coating, in order to remove disruptive gel particles.

The auxiliary material is used only temporarily—that is, the auxiliary material is removed, at the latest, immediately prior to the use of the adhesive sheet. On its coating side, this temporary auxiliary material advantageously has a surface roughness Rₐ of not more than 0.04 μm and R_{z} of not more than 0.16 μm.

When the auxiliary material is removed, there must not be an increase in the surface roughness of the adhesive surface. Therefore it has proved to be advantageous for the adhesive-bearing coating side of the auxiliary material to have an anti-adhesive effect or an anti-adhesive coating. As auxiliary material it is common to use release films or release papers which have a silicone or fluorosilicone coating. Such release films and release papers can be obtained, for example, from Laufenberg GmbH, Loparex B.V., CP Films Inc., Mondi Inncoat GmbH, Siliconature SpA, and Schleipen & Erkens GmbH. The release films and release papers available commercially as standard, however, have a significantly higher surface roughness Rₐ of >0.1 μm and R_{z}, of >1.0 μm, and are therefore not suited to the production of the adhesive sheet of the invention. In order to obtain a release film having a low surface roughness Rₐ of not more than 0.04 μm and R_{z} of not more than 0.16 μm, it is necessary to use a very smooth base film. The most suitable for this purpose are polyester films, polyethylene terephthalate for example, which at least on the coating side have no anti-blocking agents, or have such agents at least only to a small extent. Anti-blocking agents are, for example, silicon oxide particles which project from the surface of the polymeric film in order thereby to prevent the close lie of adjacent film layers on winding, i.e. what is referred to as blocking or welding. One polyester film suitable by way of example is Lumirror from Toray Inc. The coating side of these films is advantageously furnished with an anti-adhesive coating of polysiloxane. The polysiloxane coating, however, must not deleteriously increase the surface roughness. Therefore the polysiloxane coating is advantageously applied by means of a solvent.

The special coating technique leads to a very smooth adhesive surface having a surface roughness Rₐ of not more than 0.03 μm and R_{z} of not more than 0.10 μm, thereby minimizing scattered reflection (diffuse reflection) at the surface, meaning that the HAZE value is not more than 3%. A considerable contribution to this is made by the use of the very smooth release film.

Surprisingly it is possible to produce a highly transparent adhesive sheet of the invention, with a transmittance close to the theoretical maximum achievable transmittance, which is very highly suited to the covering of reaction vessels and channels, not least for use for covering microtitre plates for real time quantitative PCR application.

Accordingly the use of the adhesive sheet of the invention as a temporary or permanent masking film for microtitre plates represents one preferred use possibility.

### Test Methods

### Transmittance

The transmittance or degree of transmission is the ratio of the light output on the reverse of a body through which light is transmitted, to a comparison beam path, usually in %. The transmittance of the adhesive film and of the backing film is determined using a Uvikon 923 spectrophotometer from Koutron AG (without Ulbricht sphere) in accordance with DIN EN ISO 13468-2 at a wavelength of 450 to 750 nm.

### HAZE Measurement

The HAZE value describes the fraction of transmitted light which is scattered to the front by the irradiated sample. Consequently the HAZE value quantifies material defects in the surface or the structure that disrupt the clear through-view.

The method of measuring the haze value is described in the standard ASTM D 1003. The standard requires the recording of four spectra. For each spectrum the light transmittance is calculated. The four transmittances are converted into the percentage haze value. The HAZE value is measured using a haze-guard dual from Byk-Gardner GmbH.

### Refractive Index

The refractive index is a material constant and gives the optical density or the rate of propagation of light waves within a material. The refractive index of the adhesives is determined using an Abbe refractometer in accordance with DIN 51423. For the refractive index of the backing films, literature data or manufacturer specifications are used. In accordance with the DIN specification, measurement takes place with temperature conditioning at 20° C. and at a wavelength of 589 nm using a sodium spectral lamp (refractive index for the sodium d-line corresponding to 589 nm at 20° C.).

### Surface Roughness

The surface roughness of the adhesive, of the backing film and of the auxiliary material is measured using a Confocal-Multi-Pinhole instrument from Nanofocus GmbH in accordance with DIN EN ISO 4287 (with 0.08 mm Gaussian filter). The values determined are Rₐ and R_{z}.

Rₐ, the arithmetic average roughness, is the arithmetic mean of all of the profile values of the roughness profile.

The individual roughness depth R_{zi}, is the sum of the height of the greatest profile peak and the depth of the greatest profile valley of the roughness profile within an individual sampling length.

The roughness depth R_{z} is the arithmetic mean of the individual roughness depths R_{zi}, of successive individual sampling lengths, evaluation here taking place on the basis of five successive individual sampling lengths:

$${R}_{z} = \frac{1}{n} ( {R}_{z 1} + {R}_{z 2} + … + {R}_{z n} )$$

The maximum roughness depth Rₘₐₓ is the greatest individual roughness depth within the total sampling length.

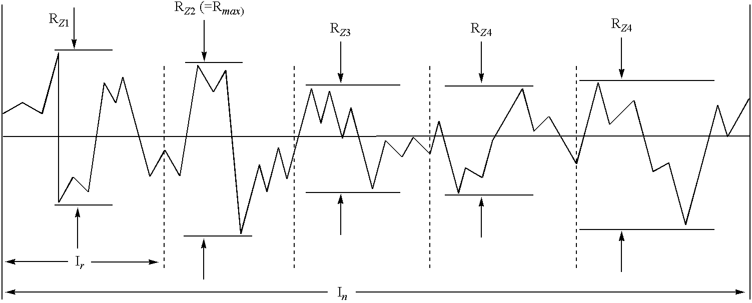

### Bond Strength Measurement

The peel strength (bond strength) is tested in accordance with PSTC-1. A strip 2 cm wide of a specimen produced as described below is adhered to a steel or polystyrene plate by being rolled over back and forth three times using a 2 kg roller. The plate is clamped in and the pressure-sensitive adhesive strip is peeled from its free end on a tensile testing machine at a peel angle of 180° and at a speed of 300 mm/min.

### Liquid Losses in PCR Measurement

All 96 wells of a microtitre plate are filled each with 50 μl of a coloured aqueous solution. The surface of the plate is dried with a lint-free cloth in order to remove adhering liquid droplets.

The plate is then sealed with the adhesive sheet of the invention, the sheet being applied centrally to the plate and pressed down thoroughly all around using an applicator of the kind customary for this purpose. The weight of the plate is ascertained on an analytical balance.

A temperature programme is run as follows:
1: 94° C. 2 min
2: 94° C. 15 s
3: 50° C. 15 s
4: 72° C. 30 s
5: 72° C. 2 min
   with steps 2 to 4 being repeated 30 times.

The system is then conditioned at 22° C. After inspection to see whether all of the wells are still filled, the specimens are weighed again after 24 h.

The evaporation or weight loss is then calculated as a percentage.

The invention is explained in more detail below, with reference to examples, without thereby wishing to restrict the invention in any form whatsoever.

### EXAMPLES

Qualities of the raw materials used:
Kraton FG 1901 SEBS (styrene-ethylene/butylene-styrene block copolymer), 100% triblock, block polystyrene content: 30% by weight, modified with about 2% by weight maleic anhydride, Kraton polymers
Kraton FG 1924 SEBS (styrene-ethylene/butylene-styrene block copolymer), about 41% by weight diblock, block polystyrene content: 13% by weight, modified with about 1.3% by weight maleic anhydride, Kraton polymers
Regalite R 1100 hydrogenated C₉ resin with a softening point of around 100° C., Eastman Chemicals
Kristalex 1140 pure aromatic resin as endblock reinforcer, with a softening point of around 140° C., Eastman
Escorez 5600 aromatic-modified, cycloaliphatic hydrocarbon resin with a softening point of around 104° C., Exxon Mobil
Shellflex 371 naphthenic oil, Shell

### Example 1

The constituents of the pressure-sensitive adhesive, composed of 40 parts of Kraton FG 1901, 60 parts of Kraton FG 1924, 100 parts of Regalite R 1100, 20 parts of Shellflex 371 and 10 parts of Kristalex 1140, are dissolved in a 40:40:20 mixture of toluene/benzene/isopropanol, to give a solids content of 40% by weight. Shortly before coating, 1 part of aluminium acetylacetonate, dissolved at 10% by weight in toluene, is added to the mixture and distributed homogeneously by stirring.

Coating takes place by means of a nozzle coating operation onto a siliconized polyester release film (transparent PET film with polysiloxane release coating from solution, thickness 50 μm, Rₐ=0.02 μm, R_{z}, =0.11 μm), the film of pressure-sensitive adhesive being placed contactlessly onto the release film. Subsequently the layer of pressure-sensitive adhesive is dried in a drying tunnel in which the temperature rises from 30° C. at the start to 110° C. at the end. The coating add-on is set such that the weight per unit area of the dry pressure-sensitive adhesive is 50 g/cm². After drying has taken place, the backing film is laminated to the open side of the layer of pressure-sensitive adhesive. The backing film used is the polypropylene film Rayowweb CR 50 from Innovia Films Ltd. (biaxially oriented, transmittance 90%, HAZE 1.5%, refractive index 1.58).

### Example 2

In the same way as for Example 1, a pressure-sensitive adhesive, composed of 40 parts of Kraton FG 1901, 60 parts of Kraton FG 1924 and 120 parts of Escorez 5600, is dissolved, coated and dried, using a siliconized polyester release film as auxiliary material (white PET film with polysiloxane release coating from solution, thickness 50 μm, Rₐ=0.03 μm, R_{z}=0.14 μm). The backing film used is the PET film Melinex 401 from DuPont Teijin Films (biaxially oriented, transmittance 88%, HAZE 0.3%, refractive index 1.51).

### Counter-Example 1

For comparison the product 9795 from 3M Inc. (available commercially as Absolut™ QPCR Seal from Thermo Fischer Scientific Inc.) is investigated. The adhesive sheet is composed of a PP backing film coated on one side with a pressure-sensitive silicone adhesive.

The transparency of the product is relatively poor, and so, at least for real time quantitative PCR application, it is thought likely that the signal/noise ratio will be unsatisfactory.

### Counter-Example 2

Pressure-sensitive adhesive is coated in the same way as in Example 1, by means of comma bar coating, onto a standard PET release film (transparent PET film with polysiloxane release coating (100% system), thickness 50 μm, Rₐ=0.26 μm, R_{z}=1.3 μm), dried and laminated with a backing film in the same way as in Example 1. Owing to the use of a standard release film and the standard contact coating technique, this specimen has a very high surface roughness and hence relatively poor transmittance values. Furthermore, as a result of the coating technique, the specimen exhibits defects which affect the optical quality.

### Counter-Example 3

For comparison the commercial product Biozym Optical from Biorad Laboratories Inc. is investigated. The adhesive sheet is composed of a PET backing film coated on one side with a pressure-sensitive acrylate adhesive. For improved comparability, the smooth, siliconized polyester release film from Example 2 is laminated to the pressure-sensitive adhesive of the adhesive sheet. Subsequently this assembly is stored under a 10 kg metal block at 40° C. for one week. By this procedure it was possible to achieve pressure-sensitive adhesive surface roughnesses very close to those of Example 2.

In comparison to Examples 1 and 2, the adhesive sheet exhibits relatively poor transmittance values. This is because of the combination of a pressure-sensitive acrylate adhesive and a PP backing, and the associated additional transmittance loss as a result of reflection at the interface, owing to the large difference in refraction between the two materials.

| | | | | |
|---|---|---|---|---|
| | | Counter- | Counter- | Counter- |
| Example 1 | Example 2 | example 1 | example 2 | example 3 |

Pressure-sensitive adhesive

| | | | | | |
|---|---|---|---|---|---|
| Type of pressure- | Styrene block | Styrene block | Silicone | Styrene block | Acrylate |
| sensitive adhesive | copolymer | copolymer | polymer | copolymer | copolymer |
| Refractive index | 1.51 | 1.51 | unknown | 1.51 | 1.47 |

Auxiliary material

| | | | | | | |
|---|---|---|---|---|---|---|
| Nature of | | Siliconized | Siliconized | Siliconized | Siliconized | Siliconized |
| auxiliary material | | PET film | PET film | PET film | PET film | PET film |
| Surface | μm | 0.02 | 0.04 | 0.07 | 0.26 | 0.04 |
| roughness Rₐ | | | | | | |
| Surface | μm | 0.11 | 0.16 | 0.36 | 1.3 | 0.16 |
| roughness R_{z} | | | | | | |

Backing material

| | | | | | | |
|---|---|---|---|---|---|---|
| Nature of backing | | PP film | PET film | PP film | PP film | PET film |
| Transmittance | % | 90 | 88 | unknown | 90 | unknown |
| HAZE | % | 1.5 | 0.3 | unknown | 1.5 | unknown |
| Refractive index | | 1.49 | 1.58 | 1.49 | 1.49 | 1.58 |

Product properties

| | | | | | | |
|---|---|---|---|---|---|---|
| Surface | μm | 0.01 | 0.03 | 0.09 | 0.29 | 0.05 |
| roughness Rₐ of | | | | | | |
| pressure-sensitive | | | | | | |
| adhesive | | | | | | |
| Surface | μm | 0.04 | 0.10 | 0.31 | 0.89 | 0.15 |
| roughness R_{z} of | | | | | | |
| pressure-sensitive | | | | | | |
| adhesive | | | | | | |
| Transmittance | % | 90 to 92 | 89 to 90 | 81 to 85 | 84 to 86 | 82 to 85 |
| (450 to 750 nm) | | | | | | |
| HAZE | % | 1.7 | 2.0 | 7.3 | 8.3 | 5.8 |
| Bond strength to | N/cm | 4.1 | 3.6 | 5.4 | 3.9 | 2.7 |
| steel | | | | | | |
| Bond strength to | N/cm | 1.5 | 1.4 | 0.2 | 1.5 | 2.0 |
| polypropylene | | | | | | |
| Liquid losses PCR | % | 0.9 | 1.4 | 1.1 | 1.2 | 2.8 |

1. Adhesive sheet for sealing vessels and channels in which chemical, biological or biochemical reactions are conducted, composed of a backing film coated on one side with a pressure-sensitive adhesive, wherein the adhesive sheet has a transmittance of at least 89% in the wavelength range between 450 to 750 nm and a HAZE value of not more than 3% and the surface of the pressure-sensitive adhesive has a surface roughness Ra of not more than 0.03 μm and Rz of not more than 0.10 μm, the refractive index of the pressure-sensitive adhesive being less than 1.55, and the difference in the refractive indices of pressure-sensitive adhesive and of backing film being not more than 0.1.

2. Adhesive sheet according to claim 1, wherein the difference in the refractive indices of pressure-sensitive adhesive and backing film is not more than 0.03.

3. Adhesive sheet according to claim 1 wherein the transmittance of the adhesive sheet is at least 91%.

4. Adhesive sheet according to claim 1, wherein the pressure-sensitive adhesive and/or backing film are free from raw materials and/or additives which cause absorption or inherent fluorescence.

5. Adhesive sheet according to claim 1, wherein the pressure-sensitive adhesive is formed from at least one acid-modified or acid anhydride-modified vinylaromatic block copolymer, at least one tackifying resin and optionally at least one metal chelate.

6. Adhesive sheet according to claim 1, wherein the adhesive contains a fraction of 20% to 70% by weight, of vinylaromatic block copolymer, based on the total weight of adhesive, optionally less than all of the block copolymers being anhydride-modified or acid-modified, and the block copolymers optionally being at least partly hydrogenated.

7. Adhesive sheet according to claim 1, wherein the vinylaromatic block copolymers are styrene block copolymers.

8. Adhesive sheet according to claim 1, wherein the fraction of acid and/or acid anhydride is between 0.5% and 4% by weight, based on the total weight of block copolymer.

9. Adhesive sheet according to claim 1, wherein the adhesive comprises further elastomers and/or further acids or acid anhydrides.

10. Adhesive sheet according to claim 1, further comprising tackifying resins of hydrogenated C5, C5/C9 or C9 hydrocarbon resins.

11. Adhesive sheet according to claim 1, wherein the surface of the pressure-sensitive adhesive has a surface roughness Ra of not more than 0.02 μm and Rz of not more than 0.07 μm.

12. Adhesive sheet according to claim 1, wherein the backing film of the adhesive sheet is a polypropylene film or a polyethylene terephthalate film.

13. Adhesive sheet according to claim 1, wherein the adhesive sheet further comprises a temporary auxiliary material.

14. Adhesive sheet according to claim 13, wherein the temporary auxiliary material is composed of a polymeric film coated with a polydimethylsiloxane release coating, the coating being advantageously applied from solution.

15. Adhesive sheet according to claim 14, wherein the surface of the temporary auxiliary material that is coated with said release coating has a surface roughness Ra of not more then 0.04 μm and Rz of not more than 0.16 μm.

16. Adhesive sheet according to claim 1, wherein the backing film has a refractive index of not more than 1.6.

17. A method for covering microtitre plates, which comprises covering said microtitre plates with the adhesive sheet of claim 1.

18. The adhesive sheet of claim 14, wherein said polymeric film is a PET film.
